(19) United States
(12) Patent Application Publication
(10) Pub. No.: US 2026/0247222 A1
(43) Pub. Date: Aug. 20, 2026

(54) PRE-ALLOCATED RESOURCE MANAGEMENT METHOD EMPLOYED BY WIRELESS COMMUNICATION DEVICE

(71) Applicant: MEDIATEK INC., Hsin-Chu (TW)

(72) Inventors: Chien-Fang Hsu, Hsinchu City (TW); Chih-Chun Kuo, Hsinchu City (TW)

(73) Assignee: MEDIATEK INC., Hsin-Chu (TW)

(21) Appl. No.: 19/474,722

(22) PCT Filed: Jul. 18, 2024
(86) PCT No.: PCT/CN2024/106168

§ 371 Date: Oct. 12, 2025

Related U.S. Application Data
(60) Provisional application No. 63/514,824, filed on Jul. 21, 2023.

(51) Int. Cl. H04W 28/26; H04W 28/02; H04W 72/121; H04W 72/543

(52) U.S. Cl. CPC H04W 28/26; H04W 28/0236; H04W 72/121; H04W 72/543

(57) ABSTRACT

One pre-allocated resource management method includes: before a traffic with a wireless communication device actually occurs, pre-allocating at least one resource, and indicating that the at least one resource is pre-allocated for the wireless communication device. For example, the traffic may be a latency sensitive traffic, and the at least one resource may include resource unit (RU) allocation, media access control (MAC) protocol data unit (MPDU) allocation, and/or transmission opportunity (TXOP) period allocation.

### FIELD OF THE INVENTION

The present invention relates to wireless communications, and more particularly, to a pre-allocated resource management method employed by a wireless communication device such as a Wi-Fi access point (AP) or a Wi-Fi non-AP station (STA).

### BACKGROUND AND RELATED ART

Wireless communication networks are widely deployed to provide various communication services such as telephony, video, data, messaging, broadcasts, and so on. Such networks support communications for multiple users by sharing the available network resources. Within such wireless networks, a variety of data services may be provided. More recently, wireless communication networks are being utilized for an even broader range of services, including low-latency applications such as gaming applications, where real-time feedback is necessary. Thus, there is a need for an innovative resource management design which is capable of serving low-latency traffic in time to achieve high quality of service.

### SUMMARY

One of the objectives of the claimed invention is to provide a pre-allocated resource management method employed by a wireless communication device such as a Wi-Fi AP or a Wi-Fi non-AP STA.

According to a first aspect of the present invention, an exemplary pre-allocated resource management method is disclosed. The exemplary pre-allocated resource management method includes: before a traffic with a wireless communication device actually occurs, pre-allocating at least one resource, and indicating that the at least one resource is pre-allocated for the wireless communication device.

According to a second aspect of the present invention, an exemplary pre-allocated resource management method employed by a wireless communication device is disclosed. The exemplary pre-allocated resource management method includes: dealing with a traffic between the wireless communication device and another wireless communication device through at least one resource, wherein the at least one resource is pre-allocated by the another wireless communication device for the wireless communication device before the traffic actually occurs; and after the traffic is initiated, determining an end of the at least one resource that is pre-allocated for the wireless communication device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system that supports the proposed pre-allocated resource management method according to an embodiment of the present invention.

FIG. 2 is a diagram illustrating a QoS Characteristics element in a frame that is used for candidate registration according to an embodiment of the present invention.

FIG. 3 is a diagram illustrating a Control info field with a reserved bit serving as a registration bit according to an embodiment of the present invention.

FIG. 4 is a diagram illustrating RU allocation with one RU pre-allocated by an AP according to an embodiment of the present invention.

FIG. 5 is a diagram illustrating RU allocation with multiple RUs pre-allocated by an AP according to an embodiment of the present invention.

FIG. 6 is a diagram illustrating RU allocation in an MU-MIMO scenario according to an embodiment of the present invention.

FIG. 7 is a diagram illustrating RU allocation in an MU A-MPDU scenario according to an embodiment of the present invention.

FIG. 8 is a diagram illustrating MPDU allocation according to an embodiment of the present invention.

FIG. 9 is a diagram illustrating some padding options according to an embodiment of the present invention.

FIG. 10 is a diagram illustrating TXOP period allocation according to an embodiment of the present invention.

FIG. 11 is a diagram illustrating MPDU allocation with an indication of end of transmission according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ” . Also, the term “couple” is intended to mean either an indirect or direct electrical connection. Accordingly, if one device is coupled to another device, that connection may be through a direct electrical connection, or through an indirect electrical connection via other devices and connections.

For latency sensitive traffic (low latency traffic) in wireless communication systems, a device (e.g. AP in Wi-Fi system) may pre-allocate resources in advance so that when the latency sensitive traffic (low latency traffic) comes, it can be transmitted or be queued immediately to meet the latency bound. For example, the pre-allocated resources can be, but not limited to, a resource unit (RU) of a physical layer protocol data unit (PPDU), a media access control (MAC) protocol data unit (MPDU) of an aggregate MPDU (A-MPDU) inside a PPDU, a time period of a transmission opportunity (TXOP), a time period allowing spatial reuse during a transmitted PPDU, and a preemption period of a TXOP allocated for non-TXOP holder(s). The pre-allocated resource can be allocated to a wireless communication device (e.g. a client STA associated to a Wi-Fi AP). However, before using the pre-allocated resource to improve the latency sensitive traffic (low latency traffic) performance, several topics need to be addressed. For example, the topics to be addressed may include how to indicate the device in advance before the real allocation, how the device knows the upcoming pre-allocated resource is for itself, and how the device knows resource allocation ends. To address these topics, the present invention proposes a pre-allocated resource management method.

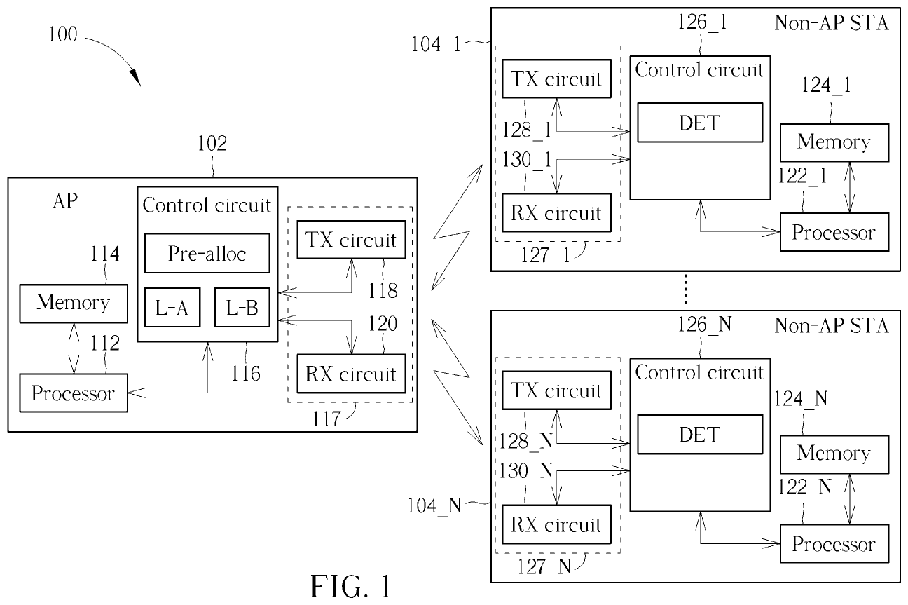

FIG. 1 is a diagram illustrating a wireless communication system that supports the proposed pre-allocated resource management method according to an embodiment of the present invention. The wireless communication system 100 may be a Wi-Fi system compliant with IEEE 802.11ax (Wi-Fi 6) standard, IEEE 802.11be (Wi-Fi 7) standard, IEEE 802.11bn (Wi-Fi 8) standard, or a next-generation Wi-Fi standard. The wireless communication system 100 includes a plurality of wireless communication devices, such as an AP 102 and multiple non-AP STAs 104_1-104_N (N≥1).

By way of example, but not limitation, AP 102 and non-AP STAs 104_1-104_N may have the same or similar circuit structure. As shown in FIG. 1, AP 102/non-AP STA 104_1/non-AP STA 104_N includes a processor 112/122_1/122_N, a memory 114/124_1/124_N, a control circuit 116/126_1/126_N, and a network interface circuit 117/127_1/127_N, where the network interface circuit 117/127_1/127_N includes a transmitter (TX) circuit 118/128_1/128_N and a receiver (RX) circuit 120/130_1/130_N. The memory 114/124_1/124_N is arranged to store a program code. The processor 112/122_1/122_N is arranged to load and execute the program code to manage the AP 102/non-AP STA 104_1/non-AP STA 104_N. The control circuit 116/126_1/126_N is arranged to control communications with other devices. For example, the control circuit 116/126_1/126_N controls the TX circuit 118/128_1/128_N of the network interface circuit 117/127_1/127_N to send packets (i.e., PPDUs) to non-AP STA/AP, and controls the RX circuit 120/122_1/122_N of the network interface circuit 117/127_1/127_N to receive packets (i.e., PPDUs) from non-AP STA/AP.

It should be noted that only the components pertinent to the present invention are illustrated in FIG. 1. In practice, each of AP 102 and non-AP STAs 104_1-104_N may include additional components to achieve designated functions.

The AP 102 and non-AP STAs 104_1-104_N support the proposed pre-allocated resource management method. The proposed pre-allocated resource management method may include AP-side operations and STA-side operations. For example, the AP-side operations may be used to address the topics of how to indicate the device in advance before the real allocation and how the device knows the upcoming pre-allocated resource is for itself, and the STA-side operations may be used to address the topic of how the device knows resource allocation ends.

As shown in FIG. 1, the control circuit 116 of the AP 102 supports a resource pre-allocation function (labeled by “Pre-alloc”), and may generate one or more lists L-A, L-B, where a candidate device of using pre-allocated resource is recorded on the list L-A/L-B, and each candidate device on the list L-A/L-B may be one of the non-AP STAs 104_1-104_N associated to the same AP 102. In some embodiments of the present invention, the control circuit 116 may generate the list L-A only, where the list L-A is generated through candidate negotiation/registration. That is, each candidate device on the list L-A is identified through candidate negotiation/registration. In some embodiments of the present invention, the control circuit 116 may generate the list L-B only, where the list L-B is generated without using candidate negotiation/registration. That is, each candidate device on the list L-B is not identified through candidate negotiation/registration before the list L-B is generated. In some embodiments of the present invention, the control circuit 116 may generate both lists L-A and L-B, where the list L-B may be a subset of the list L-A. That is, before the list L-B is generated, the control circuit 116 may identify each of a plurality of non-AP STAs associated to the same AP 102 as a candidate device of using pre-allocated resource through candidate negotiation/registration. After the list L-A is generated through candidate negotiation/registration, candidate devices announced by the list L-B are a subset of the plurality of non-AP STAs on the list L-A.

Before a traffic (e.g., latency sensitive traffic) with a client device (e.g., one of non-AP STAs 104_1-104_N) actually occurs, the AP 102 performs the resource pre-allocation function to pre-allocate at least one resource, and indicates that the at least one resource is pre-allocated for the client device (e.g., one of non-AP STAs 104_1-104_N) that is on the list L-A/L-B. It should be noted that, the resource pre-allocation function of the control circuit 116 may pre-allocate resources for different client devices on the list L-A/L-B, and indicate that the resources are pre-allocated for the different client devices.

Regarding the non-AP STA 104_1/104_N, the control circuit 126_1/126_N may deal with a traffic (e.g., latency sensitive traffic) between the non-AP STA 104_1/104_N and the AP 102 through at least one resource that is pre-allocated by the AP 102 for the non-AP STA 104_1/104_N before the traffic actually occurs. In some embodiments of the present invention, the control circuit 126_1/126_N may support a detection function (labeled by “DET”) for determining an end of at least one resource that is pre-allocated for the non-AP STA 104_1/104_N after the traffic (e.g., latency sensitive traffic) between the AP 102 and the non-AP STA 104_1/104_N is initiated.

The proposed pre-allocated resource management method is capable of addressing several topics, including how to indicate the device in advance before the real allocation, how the device knows the upcoming pre-allocated resource is for itself, and how the device knows resource allocation ends. Details of the proposed pre-allocated resource management method are described as below.

Regarding the topic of how to indicate the device in advance before the real allocation, candidate negotiation/registration may be used for setting the list L-A that can be referenced by the AP 102 to know which client device is a candidate device of using pre-allocated resource. In a first exemplary candidate negotiation/registration design, a client device (e.g., one of non-AP STAs 104_1-104_N) that has latency sensitive traffic (low latency traffic) may send a request frame to request for being a candidate device of using pre-allocated resource. After the AP 102 receives the request frame, it may send a response frame to accept or reject the request. If the AP 102 accepts the request, the client device (e.g., one of non-AP STAs 104_1-104_N) is added to the list L-A. In some embodiments of the present invention, the candidacy may be valid depending on the traffic type and/or the type of the pre-allocated resource that may be indicated in the request frame. For example, the client device (e.g., one of non-AP STAs 104_1-104_N) is a valid candidate device only when an RU is pre-allocated in a PPDU. For another example, the client device (e.g., one of non-AP STAs 104_1-104_N) is not a valid candidate device for a preemption period of a TXOP.

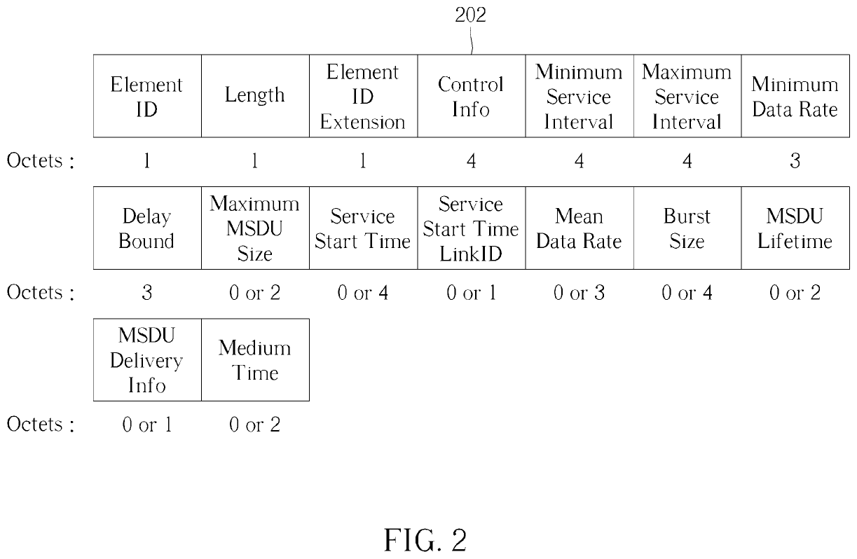

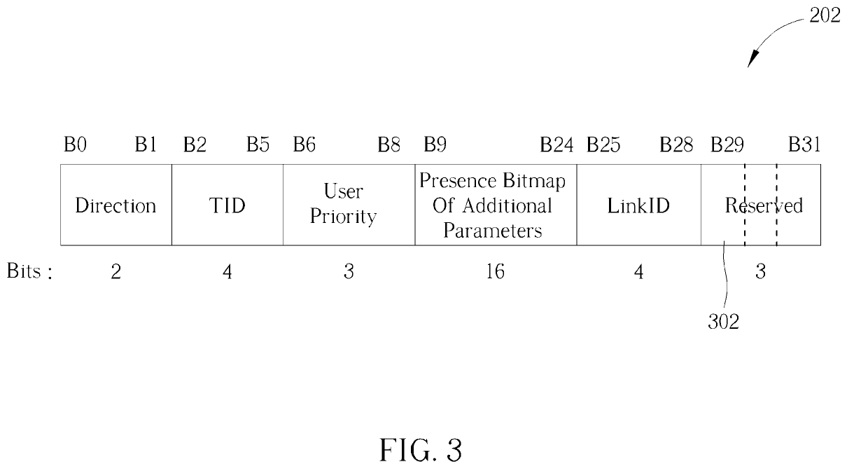

In a second exemplary candidate negotiation/registration design, the AP 102 may automatically register a client device (e.g., one of non-AP STAs 104_1-104_N) as a candidate device of using pre-allocated resource in response to a traffic of the client device that occurs under a QoS mechanism. For example, the client device may have negotiated a stream classification service (SCS) stream with the AP 102 to meet the QoS requirements of latency sensitive traffic. Hence, the client device is automatically added to the list L-A, and requires no additional negotiation to be a candidate device. For another example, the client device (e.g., one of non-AP STAs 104_1-104_N) may have sent the AP 102 a frame with a QoS Characteristics element specifying QoS requirements of a traffic identifier (TID). FIG. 2 is a diagram illustrating a QoS Characteristics element format quoted from IEEE 802.11be draft standard, where the Control Info field 202 can specify a TID and UL/DL (direction) with QoS requirements. For yet another example, the client device (e.g., one of non-AP STAs 104_1-104_N) may set the Control Info field 202 to carry an extra indication to register as a candidate. FIG. 3 is a diagram illustrating a Control Info field format quoted from IEEE 802.11be draft standard, where one reserved bit B29 may be used to serve as a registration bit 302 for explicit candidacy registration.

In some embodiments of the present invention, the AP 102 may assign an additional group identifier GID to multiple client devices (e.g., some or all of non-AP STAs 104_1-104_N), where the group identifier GID serves as a latency sensitive client group (low latency client group) ID, and is different from an association identifier AID of each client device in the same latency sensitive client group (low latency client group). Hence, each client device assigned with the group identifier GID is treated as a candidate device of using pre-allocated resource. For example, each candidate device on the list L-A may be automatically assigned with the additional group identifier GID different from its association identifier AID.

Alternatively, regarding the topic of how to indicate the device in advance before the real allocation, candidate announcement per pre-allocation may be adopted. The list L-B may be a candidate list that announces candidate devices of using pre-allocated resources with/without negotiation/registration. Specifically, the AP 102 generates the list L-B as a candidate list, and sends the candidate list that announces candidate devices of using pre-allocated resources. Hence, when a client device (e.g., one of non-AP STAs 104_1-104_N) is on the candidate list, it is announced as a candidate device of using pre-allocated resource.

For a TXOP period allocation case, the AP 102 may transmit a frame carrying the list L-B (which is the candidate list indicating candidate devices that are expected to have traffic with the TXOP owner) before data frame exchange.

For an RU allocation case, the AP 102 may use a preamble (e.g., signal (SIG) field of preamble) of a PPDU to carry the list L-B (which is the candidate list) so that a client device (e.g., one of non-AP STAs 104_1-104_N) capable of decoding the preamble (e.g., SIG field of preamble) can know the candidacy of the RU allocation of the PPDU.

When the list L-A generated from candidate negotiation/registration is available before the AP 102 starts generating the list L-B (which is the candidate list for candidate announcement), the list L-B generated by the AP 102 may be a subset of the list L-A. However, this is for illustrative purposes only, and is not meant to be a limitation of the present invention. In an alternative design of candidate announcement per pre-allocation, none of candidate devices announced by the list L-B is identified as a candidate device of using pre-allocated resource before the list L-B is generated. For example, an ad hoc candidate list can be announced to client devices without negotiation/registration for special usages (e.g., collecting emergency traffic from those client devices).

Regarding the topic of how the device knows the upcoming pre-allocated resource is for itself, the pre-allocated resource can be allocated in different ways, and the pre-allocated resource can be indicated to the client device in different ways. In one pre-allocated resource indication design, the AP 102 may set a preamble (e.g., SIG field of preamble) of a PPDU to indicate that at least one resource is pre-allocated for at least one client device (e.g., one or more of non-AP STAs 104_1-104_N). For example, the preamble (e.g., SIG field of preamble) may carry at least one identifier (e.g., a group identifier GID and/or an association identifier AID) of at least on candidate device of using the pre-allocated resource. That is, a client device knows that the pre-allocated resource is for itself after decoding its AID and/or GID carried in the preamble (e.g., SIG field of preamble).

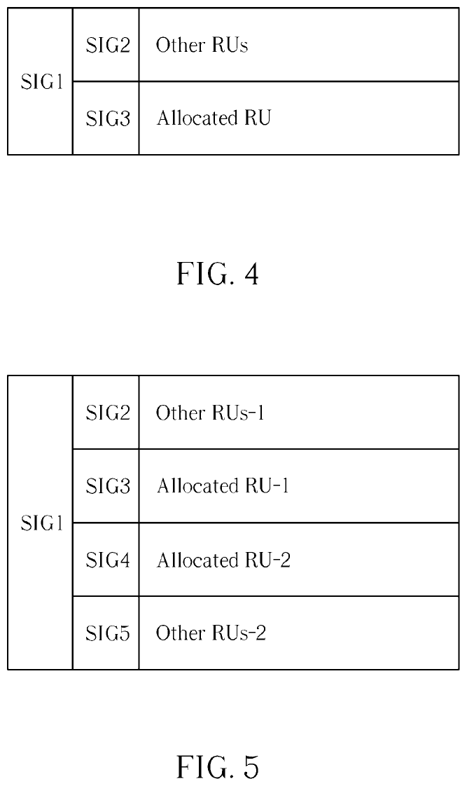

In some embodiments of the present invention, the at least one resource pre-allocated by the AP 102 may be RU allocation. The RU allocation may include only one pre-allocated RU, as illustrated in FIG. 4. When the group identifier GID is carried in the SIG field, it can be used to indicate that the pre-allocated RU is allocated to which group of client devices. When the association identifier AID is carried in the SIG field, it can be used to indicate that the pre-allocated RU is allocated to which client device. For groupcast data, setting the group identifier GID in the SIG field is enough. If both the group identifier GID and the association identifier AID are carried in the preamble (e.g., GID in SIG1 and AID in SIG3), the pre-allocated RU is allocated to an AID-indexed client device within a GID-indexed latency sensitive client group (low latency client group). When a client device knows that it does not belong to the latency sensitive client group (low latency client group) after decoding the group identifier GID in SIG1, it can stop decoding the AID in SIG3.

In some embodiments of the present invention, the RU allocation may include multiple pre-allocated RUs, as illustrated in FIG. 5. Hence, one pre-allocated RU (labeled by “RU-1”) can be allocated to one client device (which is indicated by one association identifier AID carried in the SIG field) or one latency sensitive client group (low latency client group) (which is indicated by one group identifier GID carried in the SIG field), and another pre-allocated RU (labeled by “RU-2”) can be allocated to another client device (which is indicated by another association identifier AID carried in the SIG field) or another latency sensitive client group (low latency client group) (which is indicated by another group identifier GID carried in the SIG field).

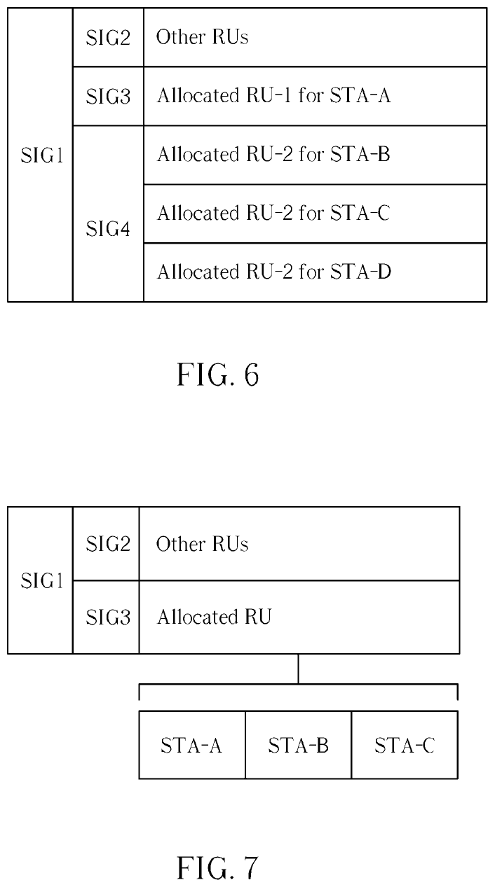

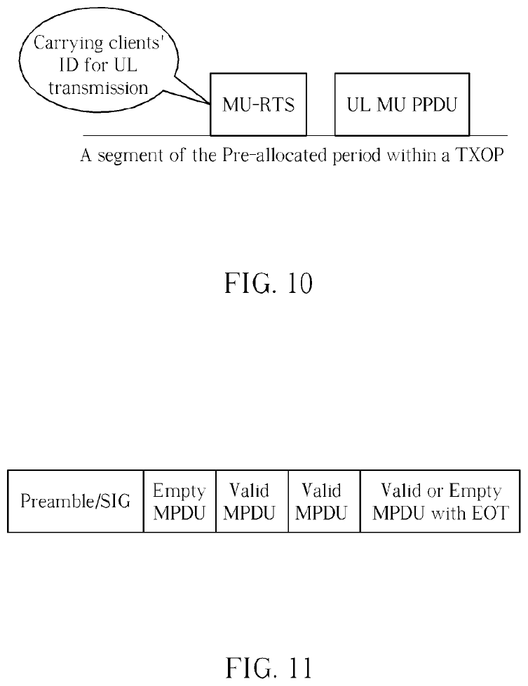

The RU allocation examples shown in FIG. 4 and FIG. 5 are for illustrative purposes only. Some RU allocation variants are shown in FIG. 6 and FIG. 7. Regarding a multi-user multiple-input multiple-output (MU-MIMO) scenario, one RU (labeled by “RU-2”) is in an MU-MIMO format as shown in FIG. 6, and is allocated to multiple client devices (labeled by “STA-B”, “STA-C”, and “STA-D”), where the preamble (e.g., SIG field of preamble) may carry at least one identifier (e.g., group identifier GID and/or association identifier AID) to indicate RU-2 is allocated to STA-B, STA-C, and STA-D. Regarding a multi-user A-MPDU scenario, the pre-allocated RU carries multiple MPDUs of multiple users (labeled by “STA-A”, “STA-B”, and “STA-C”) as shown in FIG. 10.

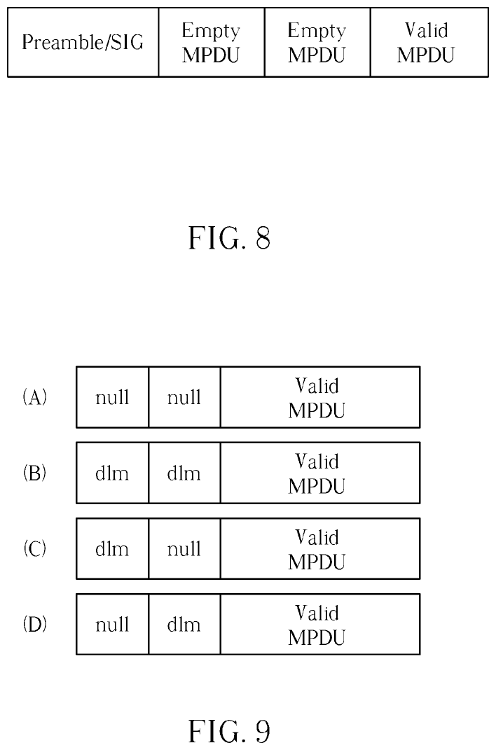

The AP 102 may set a preamble (e.g., SIG field of preamble) of a PPDU to indicate that at least one resource is pre-allocated for at least one client device (e.g., one or more of non-AP STAs 104_1-104_N), where the preamble (e.g., SIG field of preamble) may carry at least one identifier (e.g., group identifier GID and/or association identifier AID) of at least one candidate device of using the pre-allocated resource for candidacy indication. In some embodiments of the present invention, the at least one resource pre-allocated by the AP 102 may be MPDU allocation as illustrated in FIG. 8. Due to certain factors, the AP 102 may set empty MPDU(s) padded before the pre-allocated MPDU (labeled by “valid MPDU”). For example, the padding is added because the expected traffic (e.g., latency sensitive traffic) has not come yet. For another example, the padding is added because more processing time for the traffic (e.g., latency sensitive traffic) is required. The client device has to wait until it has decoded a pre-allocated MPDU for itself (identified by AID and/or GID carried in the preamble/SIG), or any other signal from the AP 102 to end the MPDU allocation. The padding arrangement shown in FIG. 8 is for illustrative purposes only, and is not meant to be a limitation of the present invention. For example, the added padding may be implemented using empty MPDU(s) and/or delimiter(s), depending upon actual design considerations. Hence, one PPDU may include a pre-allocated MPDU, and may further include at least one empty MPDU and/or at least one delimiter. FIG. 9 is a diagram illustrating some padding options (A), (B), (C), (D) according to an embodiment of the present invention, where padding can use delimiter (dlm) or empty MDPU (null) in any order.

In another pre-allocated resource indication design, the AP 102 may send a MAC frame to indicate that the at least one resource is pre-allocated for at least one client device (e.g., one or more of non-AP STAs 104_1-104_N). In some embodiments of the present invention, the at least one resource pre-allocated by the AP 102 may be TXOP period allocation. The AP 102 may divide one pre-allocated period within a TXOP into multiple segments, and send a frame to indicate the owner(s) of each segment. For example, the frame may be a request to send (RTS) frame or an MU-RTS frame. FIG. 10 is a diagram illustrating that an MU-RTS frame carries information indicating that one TXOP segment is pre-allocated to multiple client devices (e.g., some of non-AP STAs 104_1-104_N) for uplink (UL) transmission. For other client devices that are not in the pre-allocation group, they can be in the power save (PS) mode until the end of the TXOP or the end of the pre-allocated period within the TXOP.

Regarding the topic of how the device knows resource allocation ends, a client device (e.g., one of non-AP STAs 104_1-104_N) supports a detection function used for determining an end of at least one resource that is pre-allocated for the client device after the traffic (e.g., latency sensitive traffic) between the AP 102 and the client device is initiated. For an MU case (each resource pre-allocation is for multiple client devices), it is necessary to define rules to indicate the end of the transmission for each client device to save client's power and to guarantee the client can be successfully dismissed. For example, the at least one resource pre-allocated for a client device (e.g., one of non-AP STAs 104_1-104_N) by the AP 102 may include RU allocation, TXOP period allocation, and/or MPDU allocation.

For the RU allocation case, the client device (e.g., one of non-AP STAs 104_1-104_N) determines the end of the RU allocation assigned to it by decoding the RU allocation until its end.

For the TXOP period allocation case, the client device (e.g., one of non-AP STAs 104_1-104_N) determines the end of the TXOP period allocation assigned to it by receiving a frame that is sent from the AP 102 and carries an indication of “no more data” to be transmitted. In an alternative design, the client device (e.g., one of non-AP STAs 104_1-104_N) determines the end of the TXOP period allocation assigned to it by identifying an end of one frame exchange sequence (which includes sending an acknowledgment (ACK)/block acknowledgment (BA) from the client device to the AP 102) under a condition that there is only one PPDU for the client device during each TXOP. In an alternative design, the client device (e.g., one of non-AP STAs 104_1-104_N) determines the end of the TXOP period allocation assigned to it by receiving a single-user (SU) frame that is sent from the AP 102 to another client device (e.g., another of non-AP STAs 104_1-104_N). Since the AP 102 starts sending an SU frame to another client device, it implies that an allocated period of the client device has ended. In an alternative design, the client device (e.g., one of non-AP STAs 104_1-104_N) determines the end of the TXOP period allocation assigned to it by receiving an MU frame that is sent from the AP 102 and does not include an association identifier AID of the client device. Since the AP 102 starts sending an MU frame to other client devices, it implies that an allocated period of the client device has ended. In an alternative design, the client device (e.g., one of non-AP STAs 104_1-104_N) determines the end of the TXOP period allocation assigned to it by receiving a frame that is sent from the AP 102 and carries an indication of the end of the TXOP period (segment) allocation assigned to the client device.

For the MPDU allocation case, the client device (e.g., one of non-AP STAs 104_1-104_N) determines the end of the MPDU allocation assigned to it by receiving an MPDU that carries an indication of end of transmission (EOT), as illustrated in FIG. 11. When receiving such an MPDU with an EOT indication, the client device can stop decoding following MPDU(s) in the same PPDU.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pre-allocated resource management method comprising:
before a traffic with a wireless communication device actually occurs:
pre-allocating at least one resource; and
indicating that the at least one resource is pre-allocated for the wireless communication device.

2. The pre-allocated resource management method of claim 1, wherein the traffic is a latency sensitive traffic.

3. The pre-allocated resource management method of claim 1, further comprising:
receiving a request frame from the wireless communication device to request for being a candidate device of using pre-allocated resource.

4. The pre-allocated resource management method of claim 1, further comprising:
in response to a traffic of the wireless communication device that occurs under a quality of service (QOS) mechanism, automatically registering the wireless communication device as a candidate device of using pre-allocated resource.

5. The pre-allocated resource management method of claim 1, further comprising:
assigning a group identifier to a plurality of wireless communication devices, wherein the plurality of wireless communication devices comprise the wireless communication device, and each wireless communication device assigned with the group identifier is a candidate device of using pre-allocated resource.

6. The pre-allocated resource management method of claim 1, further comprising:
generating a candidate list; and
sending the candidate list that announces at least one candidate device of using pre-allocated resource, wherein the wireless communication device is on the candidate list.

7. The pre-allocated resource management method of claim 6, further comprising:
before the candidate list is generated, identifying each of a plurality of wireless communication devices as a candidate device of using pre-allocated resource;
wherein candidate devices announced by the candidate list are a subset of the plurality of wireless communication devices.

8. The pre-allocated resource management method of claim 6, wherein each candidate device announced by the candidate list is not identified as a candidate device of using pre-allocated resource before the candidate list is generated.

9. The pre-allocated resource management method of claim 1, wherein indicating that the at least one resource is pre-allocated for the wireless communication device comprises:
setting a preamble of a physical layer protocol data unit (PPDU) to indicate that the at least one resource is pre-allocated for at least the wireless communication device.

10. The pre-allocated resource management method of claim 9, wherein the preamble carries at least one identifier of the at least the wireless communication device to indicate that the at least one resource is pre-allocated for at least the wireless communication device.

11. The pre-allocated resource management method of claim 9, wherein the at least one resource comprises resource unit (RU) allocation.

12. The pre-allocated resource management method of claim 11, wherein the RU allocation includes only one pre-allocated RU.

13. The pre-allocated resource management method of claim 11, wherein the RU allocation includes multiple pre-allocated RUs.

14. The pre-allocated resource management method of claim 9, wherein the at least one resource comprises media access control (MAC) protocol data unit (MPDU) allocation.

15. The pre-allocated resource management method of claim 14, wherein the PPDU comprises a pre-allocated MPDU, and further comprises at least one empty MPDU or at least one delimiter.

16. The pre-allocated resource management method of claim 1, wherein indicating that the at least one resource is pre-allocated for the wireless communication device comprises:
sending a frame to indicate that the at least one resource is pre-allocated for at least the wireless communication device.

17. The pre-allocated resource management method of claim 16, wherein the at least one resource comprises transmission opportunity (TXOP) period allocation.

18. A pre-allocated resource management method employed by a wireless communication device, comprising:
dealing with a traffic between the wireless communication device and another wireless communication device through at least one resource, wherein the at least one resource is pre-allocated by the another wireless communication device for the wireless communication device before the traffic actually occurs; and
after the traffic is initiated, determining an end of the at least one resource that is pre-allocated for the wireless communication device.

19. The pre-allocated resource management method of claim 18, wherein the traffic is a latency sensitive traffic.

20. The pre-allocated resource management method of claim 18, wherein the at least one resource comprises resource unit (RU) allocation, and determining the end of the at least one resource that is pre-allocated for the wireless communication device comprises:
determining the end of the at least one resource by decoding the RU allocation until its end.

21. The pre-allocated resource management method of claim 18, wherein the at least one resource comprises transmission opportunity (TXOP) period allocation, and determining the end of the at least one resource that is pre-allocated for the wireless communication device comprises:
determining the end of the at least one resource by:
receiving a frame that is sent from the another wireless communication device and carries an indication of no more data; or
identifying an end of one frame exchange sequence; or
receiving a single-user (SU) frame that is sent from the another wireless communication device to yet another wireless communication device; or
receiving a multi-user (MU) frame that is sent from the another wireless communication device and does not include an identifier of the wireless communication device; or
receiving a frame that is sent from the another wireless communication device and carries an indication of the end of the at least one resource.

22. The pre-allocated resource management method of claim 18, wherein the at least one resource comprises media access control (MAC) protocol data unit (MPDU) allocation, and determining the end of the at least one resource that is pre-allocated for the wireless communication device comprises:
determining the end of the at least one resource by receiving an MPDU that carries an indication of end of transmission.
